(19) United States
(12) Patent Application Publication
(10) Pub. No.: US 2026/0203179 A1
(43) Pub. Date: Jul. 16, 2026

(54) PROGRAMMABLE NEAR MEMORY PROCESSING ENGINE FOR A MANAGED MEMORY SYSTEM

(71) Applicant: Micron Technology, Inc., Boise, ID (US)

(72) Inventors: Massimiliano PATRIARCA, Milano (IT); Daniele BALLUCHI, Cernusco Sul Naviglio (IT); Graziano MIRICHIGNI, Vimercate (IT)

(21) Appl. No.: 19/426,044

(22) Filed: Dec. 18, 2025

Related U.S. Application Data
(60) Provisional application No. 63/744,607, filed on Jan. 13, 2025.

(51) Int. Cl. G06F 11/22; G06F 13/42; G06F 17/16

(52) U.S. Cl. CPC G06F 11/2273; G06F 13/4282; G06F 17/16

(57) ABSTRACT

In some implementations, a programmable processor of a memory system may receive, from a host system, programming information, the programming information indicating one or more near memory processing (NMP) tasks that are to be performed by the programmable processor. The programmable processor may execute the one or more NMP tasks based on the programming information.

### CROSS-REFERENCE TO RELATED APPLICATION

This Patent Application claims priority to U.S. Provisional Patent Application No. 63/744,607, filed on January 13, 2025, entitled “PROGRAMMABLE NEAR MEMORY PROCESSING ENGINE FOR A MANAGED MEMORY SYSTEM,” and assigned to the assignee hereof. The disclosure of the prior Application is considered part of and is incorporated by reference into this Patent Application.

### TECHNICAL FIELD

The present disclosure generally relates to memory devices, memory device operations, and, for example, to a programmable near memory processing engine for a managed memory system.

### BACKGROUND

Memory devices are widely used to store information in various electronic devices. A memory device includes memory cells. A memory cell is an electronic circuit capable of being programmed to a data state of two or more data states. For example, a memory cell may be programmed to a data state that represents a single binary value, often denoted by a binary “1” or a binary “0.” As another example, a memory cell may be programmed to a data state that represents a fractional value (e.g., 0.5, 1.5, or the like). To store information, an electronic device may write to, or program, a set of memory cells. To access the stored information, the electronic device may read, or sense, the stored state from the set of memory cells.

Various types of memory devices exist, including random access memory (RAM), read only memory (ROM), dynamic RAM (DRAM), static RAM (SRAM), synchronous dynamic RAM (SDRAM), ferroelectric RAM (FeRAM), magnetic RAM (MRAM), resistive RAM (RRAM), holographic RAM (HRAM), flash memory (e.g., NAND memory and NOR memory), and others. A memory device may be volatile or non-volatile. Non-volatile memory (e.g., flash memory) can store data for extended periods of time even in the absence of an external power source. Volatile memory (e.g., DRAM) may lose stored data over time unless the volatile memory is refreshed by a power source. In some examples, a memory device may be associated with a compute express link (CXL) protocol and/or a CXL compliant memory system.

### BRIEF DESCRIPTION OF THE DRAWINGS

FIG. 1 is a diagram illustrating an example system capable of implementing a programmable near memory processing (NMP) engine.

FIG. 2 is a diagram illustrating another example system capable of implementing a programmable NMP engine.

FIG. 3 is a diagram of an example associated with a programmable NMP engine for a managed memory system.

FIG. 4 is a flowchart of an example method associated with a programmable NMP engine for a managed memory system.

### DETAILED DESCRIPTION

The expansion of server memory and the processing of near-memory data are critical challenges in the field of high-performance computing and data centers. Servers often require additional memory capacity and the ability to process data close to the memory to reduce latency and improve throughput. Existing architectures address these challenges by using compute express link (CXL) attached memory modules equipped with processing units. These processing units traditionally come in the form of either dedicated hardware with single functions, such as memory copy or matrix multipliers, or as several central processing units (CPUs) that can be programmed to execute a variety of tasks. However, dedicated hardware solutions are limited by their single-purpose nature, constraining their adaptability to different processing requirements. On the other hand, multi-CPU solutions, while flexible, can be inefficient, underutilized, and can lead to increased power consumption and waste of memory resources.

Moreover, existing CXL attached memory modules that incorporate processing capabilities tend to suffer from performance limitations when implemented on field programmable gate arrays (FPGAs) due to the FPGAs’ inability to run at full speed. This results in a trade-off between the flexibility offered by programmable logic and the high-speed performance requirements of memory expanders. This results in a challenge to enhance the efficiency of processing engines by integrating specialized algorithms and dedicated hardware components in a manner that optimizes performance, improves processing capabilities, and does not degrade the high-speed operation of the CXL device. Additionally, there is a need to provide a solution that allows for the programming of only the required functions in a manner that improves power efficiency, reduces memory resource usage, and optimizes area utilization.

Some implementations described herein are associated with a memory system (e.g., a CXL compliant memory system and/or a similar managed memory system) with an embedded programmable near memory processing (NMP) component, such as an FPGA (e.g., an embedded FPGA (eFPGA) on a CXL application-specific integrated circuit (ASIC)), that is capable of executing specialized near memory tasks. For example, the programmable NMP component may receive programming information from a host system, which indicates the specific NMP tasks to be performed, such as memory copying, vector-matrix multiplication, or user-defined functions, among other examples. The component may execute these tasks based on the received information, and/or may interface with a host software library for real-time programming of the tasks using a user-friendly application programming interface (API).

In some aspects, the programmable NMP component may initialize a set of user-defined algorithms for execution, perform background execution of NMP tasks while primary memory operations are conducted by memory controllers, execute built-in self-tests (BISTs) for a memory system, perform in-system memory testing tasks, manage extended error recovery processes for the memory system, and/or handle peripheral component interconnect express (PCIe) direct memory access (DMA) operations. Additionally, or alternatively, the programmable NMP component may manage data coherency of the memory system by communicating with a coherent network on chip (NoC) component when hardware coherency is required.

In this way, the memory system with the embedded programmable NMP component can enhance the efficiency of processing engines by allowing for the programming of only the necessary functions, thereby optimizing performance and improving processing capabilities without degrading the high-speed operation of the memory system. The use of an eFPGA also provides a means for real-time updates and flexibility in the processing tasks, which can be adapted to the changing needs of the host system. As a result, the memory system implementing a programmable NMP component may optimize computational throughput and minimize latency in data processing. Additionally, or alternatively, the techniques described herein may promote a reduction in energy consumption and/or may enhance the utilization of memory resources by offloading tasks that would traditionally occupy the CPU, leading to a decrease in overall system power draw and improved thermal management. In this way, the memory system may conserve processing resources, memory resources, network resources, and/or the like.

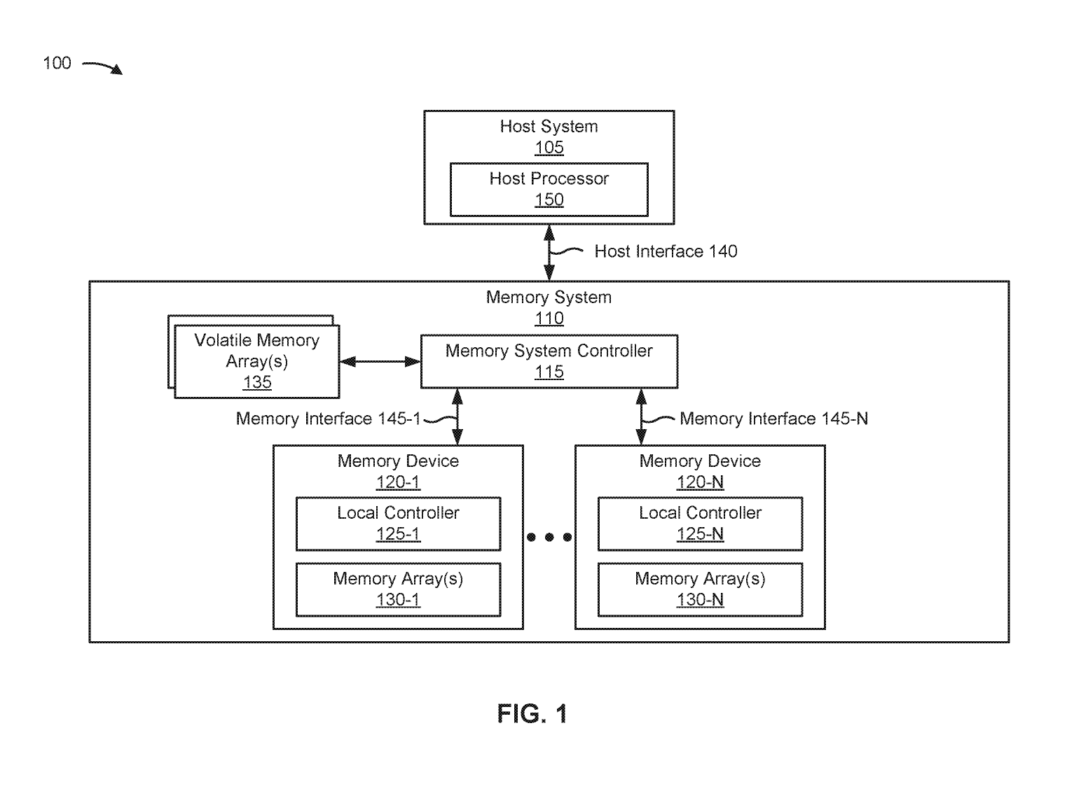

FIG. 1 is a diagram illustrating an example system 100 capable of implementing a programmable NMP engine. The system 100 may include one or more devices, apparatuses, and/or components for performing operations described herein. For example, the system 100 may include a host system 105 and a memory system 110. The memory system 110 may include a memory system controller 115 and one or more memory devices 120, shown as memory devices 120-1 through 120-N (where N ≥ 1). A memory device may include a local controller 125 and one or more memory arrays 130. The host system 105 may communicate with the memory system 110 (e.g., the memory system controller 115 of the memory system 110) via a host interface 140. The memory system controller 115 and the memory devices 120 may communicate via respective memory interfaces 145, shown as memory interfaces 145-1 through 145-N (where N ≥ 1).

The system 100 may be any electronic device configured to store data in memory. For example, the system 100 may be a computer, a mobile phone, a wired or wireless communication device, a network device, a server, a device in a data center, a device in a cloud computing environment, a vehicle (e.g., an automobile or an airplane), and/or an Internet of Things (IoT) device. The host system 105 may include a host processor 150. The host processor 150 may include one or more processors configured to execute instructions and store data in the memory system 110. For example, the host processor 150 may include a CPU, a graphics processing unit (GPU), an FPGA, an ASIC, and/or another type of processing component.

The memory system 110 may be any electronic device or apparatus configured to store data in memory. For example, the memory system 110 may be a hard drive, a solid-state drive (SSD), a flash memory system (e.g., a NAND flash memory system or a NOR flash memory system), a universal serial bus (USB) drive, a memory card (e.g., a secure digital (SD) card), a secondary storage device, a non-volatile memory express (NVMe) device, an embedded multimedia card (eMMC) device, a dual in-line memory module (DIMM), a CXL memory module, and/or a random-access memory (RAM) device, such as a dynamic RAM (DRAM) device or a static RAM (SRAM) device.

The memory system controller 115 may be any device configured to control operations of the memory system 110 and/or operations of the memory devices 120. For example, the memory system controller 115 may include control logic, a memory controller, a system controller, an ASIC, an FPGA, a processor, a microcontroller, and/or one or more processing components. In some implementations, the memory system controller 115 may communicate with the host system 105 and may instruct one or more memory devices 120 regarding memory operations to be performed by those one or more memory devices 120 based on one or more instructions from the host system 105. For example, the memory system controller 115 may provide instructions to a local controller 125 regarding memory operations to be performed by the local controller 125 in connection with a corresponding memory device 120.

A memory device 120 may include a local controller 125 and one or more memory arrays 130. In some implementations, a memory device 120 includes a single memory array 130. In some implementations, each memory device 120 of the memory system 110 may be implemented in a separate semiconductor package or on a separate die that includes a respective local controller 125 and a respective memory array 130 of that memory device 120. The memory system 110 may include multiple memory devices 120.

A local controller 125 may be any device configured to control memory operations of a memory device 120 within which the local controller 125 is included (e.g., and not to control memory operations of other memory devices 120). For example, the local controller 125 may include control logic, a memory controller, a system controller, an ASIC, an FPGA, a processor, a microcontroller, a CXL controller connected to DRAM, and/or one or more processing components. In some implementations, the local controller 125 may communicate with the memory system controller 115 and may control operations performed on a memory array 130 coupled with the local controller 125 based on one or more instructions from the memory system controller 115. As an example, the memory system controller 115 may be an SSD controller, and the local controller 125 may be a NAND controller.

A memory array 130 may include an array of memory cells configured to store data. For example, a memory array 130 may include a non-volatile memory array (e.g., a NAND memory array or a NOR memory array) or a volatile memory array (e.g., an SRAM array or a DRAM array). In some implementations, the memory system 110 may include one or more volatile memory arrays 135. A volatile memory array 135 may include an SRAM array and/or a DRAM array, among other examples. The one or more volatile memory arrays 135 may be included in the memory system controller 115, in one or more memory devices 120, and/or in both the memory system controller 115 and one or more memory devices 120. In some implementations, the memory system 110 may include both non-volatile memory capable of maintaining stored data after the memory system 110 is powered off, and volatile memory (e.g., a volatile memory array 135) that requires power to maintain stored data and that loses stored data after the memory system 110 is powered off. For example, a volatile memory array 135 may cache data read from or to be written to non-volatile memory, and/or may cache instructions to be executed by a controller of the memory system 110.

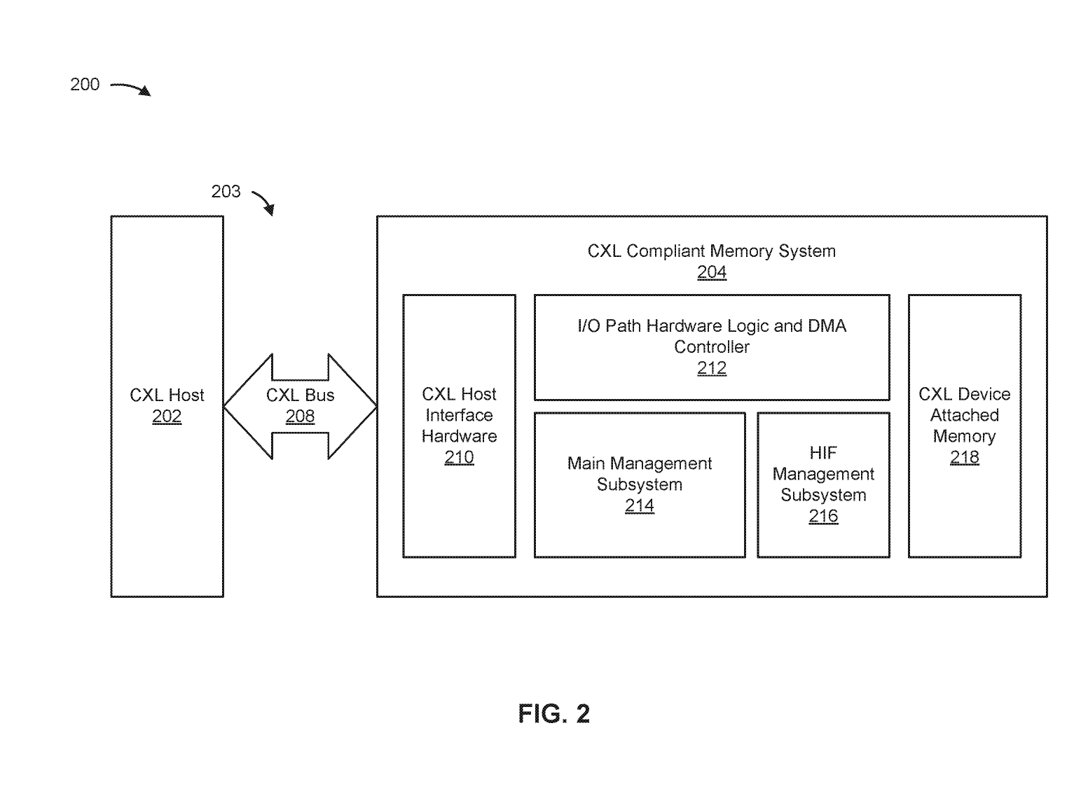

The host interface 140 enables communication between the host system 105 (e.g., the host processor 150) and the memory system 110 (e.g., the memory system controller 115). The host interface 140 may include, for example, a Small Computer System Interface (SCSI), a Serial-Attached SCSI (SAS), a Serial Advanced Technology Attachment (SATA) interface, a PCIe interface, an NVMe interface, a USB interface, a Universal Flash Storage (UFS) interface, an eMMC interface, a double data rate (DDR) interface, a DIMM interface, and/or a CXL interface (e.g., a PCIe/CXL interface, described in more detail below in connection with FIG. 2).

The memory interface 145 enables communication between the memory system 110 and the memory device 120. The memory interface 145 may include a non-volatile memory interface (e.g., for communicating with non-volatile memory), such as a NAND interface or a NOR interface. Additionally, or alternatively, the memory interface 145 may include a volatile memory interface (e.g., for communicating with volatile memory), such as a DDR interface.

Although the example memory system 110 described above includes a memory system controller 115, in some implementations, the memory system 110 does not include a memory system controller 115. For example, an external controller (e.g., included in the host system 105) and/or one or more local controllers 125 included in one or more corresponding memory devices 120 may perform the operations described herein as being performed by the memory system controller 115. Furthermore, as used herein, a “controller” may refer to the memory system controller 115, a local controller 125, or an external controller. In some implementations, a set of operations described herein as being performed by a controller may be performed by a single controller. For example, the entire set of operations may be performed by a single memory system controller 115, a single local controller 125, or a single external controller. Alternatively, a set of operations described herein as being performed by a controller may be performed by more than one controller. For example, a first subset of the operations may be performed by the memory system controller 115 and a second subset of the operations may be performed by a local controller 125. Furthermore, the term “memory apparatus” may refer to the memory system 110 or a memory device 120, depending on the context.

A controller (e.g., the memory system controller 115, a local controller 125, or an external controller) may control operations performed on memory (e.g., a memory array 130), such as by executing one or more instructions. For example, the memory system 110 and/or a memory device 120 may store one or more instructions in memory as firmware, and the controller may execute those one or more instructions. Additionally, or alternatively, the controller may receive one or more instructions from the host system 105 and/or from the memory system controller 115, and may execute those one or more instructions. In some implementations, a non-transitory computer-readable medium (e.g., volatile memory and/or non-volatile memory) may store a set of instructions (e.g., one or more instructions or code) for execution by the controller. The controller may execute the set of instructions to perform one or more operations or methods described herein. In some implementations, execution of the set of instructions, by the controller, causes the controller, the memory system 110, and/or a memory device 120 to perform one or more operations or methods described herein. In some implementations, hardwired circuitry is used instead of or in combination with the one or more instructions to perform one or more operations or methods described herein. Additionally, or alternatively, the controller may be configured to perform one or more operations or methods described herein. An instruction is sometimes called a “command.”

For example, the controller (e.g., the memory system controller 115, a local controller 125, or an external controller) may transmit signals to and/or receive signals from memory (e.g., one or more memory arrays 130) based on the one or more instructions, such as to transfer data to (e.g., write or program), to transfer data from (e.g., read), to erase, and/or to refresh all or a portion of the memory (e.g., one or more memory cells, pages, sub-blocks, blocks, or planes of the memory). Additionally, or alternatively, the controller may be configured to control access to the memory and/or to provide a translation layer between the host system 105 and the memory (e.g., for mapping logical addresses to physical addresses of a memory array 130). In some implementations, the controller may translate a host interface command (e.g., a command received from the host system 105) into a memory interface command (e.g., a command for performing an operation on a memory array 130).

In some implementations, one or more systems, devices, apparatuses, components, and/or controllers of FIG. 1 may be configured to receive, from a host system and by a programmable processor of a memory system, programming information, the programming information indicating one or more NMP tasks that are to be performed by the programmable processor; and execute the one or more NMP tasks based on the programming information.

In some implementations, one or more systems, devices, apparatuses, components, and/or controllers of FIG. 1 may be associated with a memory expander device, one or more CXL compliant memory components; one or more memory controllers operatively connected to the one or more CXL compliant memory components; and a programmable NMP engine embedded within the memory expander device and operatively connected to at least one of the one or more memory controllers or the one or more CXL compliant memory components, wherein the programmable NMP engine may be configured to receive, via a programmable interface associated with a host system, programming instructions during runtime of the memory expander device; and execute data processing tasks associated with the programming instructions.

The number and arrangement of components shown in FIG. 1 are provided as an example. In practice, there may be additional components, fewer components, different components, or differently arranged components than those shown in FIG. 1. Furthermore, two or more components shown in FIG. 1 may be implemented within a single component, or a single component shown in FIG. 1 may be implemented as multiple, distributed components. Additionally, or alternatively, a set of components (e.g., one or more components) shown in FIG. 1 may perform one or more operations described as being performed by another set of components shown in FIG. 1.

FIG. 2 is a diagram illustrating another example system 200 capable of implementing a programmable NMP engine. The system 200 may include one or more devices, apparatuses, and/or components for performing operations described herein. In some examples, the system 200 may be associated with a CXL standard and/or protocol (e.g., the system 200 may utilize a CXL protocol to communicate between a host device, sometimes referred to as a CXL compliant host or simply a CXL host, and a memory system, sometimes referred to as a CXL compliant memory system or simply a CXL memory system). In that regard, the system 200 may include a CXL host 202 (which may correspond to the host system 105) and a CXL compliant memory system 204 (which may correspond to the memory system 110). The CXL host 202 and the CXL compliant memory system 204 may communicate via an interface 203 (e.g., host interface 140), which may include a CXL bus 208 (e.g., a PCIe/CXL interface), among other examples.

In some examples, the CXL compliant memory system 204 may be a system that complies with the CXL standard and/or protocol, such as for a purpose of communicating with one or more host devices (e.g., a CXL compliant host, such as CXL host 202). CXL is an open standard that may enable high-speed CPU-to-device and CPU-to-memory interconnects designed to accelerate next-generation performance. The CXL standard may enable memory coherency between the CPU memory space and memory on attached devices, which allows resource sharing for higher performance, reduced software stack complexity, and lower overall system cost. CXL is designed to be an industry open standard for enabling an interface for high-speed communications. CXL technology utilizes the PCIe infrastructure, leveraging PCIe physical and electrical interfaces to provide an advanced protocol in areas such as input/output (I/O) protocol, memory protocol, and coherency interface.

In some examples, the system 200 may include a PCIe/CXL interface (e.g., the CXL bus 208 may be associated with a PCIe/CXL interface), which may be a physical interface configured to connect the CXL compliant memory system 204 to CXL compliant host devices, such as the CXL host 202. In such examples, the PCIe/CXL interface may comply with CXL standard specifications for physical connectivity, ensuring broad compatibility and ease of integration into existing systems using the CXL protocol. Additionally, or alternatively, the CXL compliant memory system 204 may be designed to efficiently interface with computing systems (e.g., CXL host 202 and/or a host system 105) by leveraging the CXL protocol. For example, the CXL compliant memory system 204 may be configured to utilize high-speed, low-latency interconnect capabilities of CXL, such as for a purpose of making the CXL compliant memory system 204 suitable for high-performance computing, data center applications, artificial intelligence (AI) applications, and/or similar applications.

In some examples, the CXL compliant memory system 204 may include a CXL memory system controller (e.g., a CXL ASIC, which may correspond to the memory system controller 115 and/or local controller 125), which may be configured to manage data flow between memory arrays (shown as CXL device attached memory 218, which may correspond to the volatile memory arrays 135 and/or the memory arrays 130) and a CXL interface (e.g., the CXL bus 208). In some examples, the CXL memory system controller may be configured to handle one or more CXL protocol layers, such as an I/O layer (e.g., a layer associated with a CXL.io protocol, which may be used for purposes such as device discovery, configuration, initialization, I/O virtualization, DMA using non-coherent load-store semantics, and/or similar purposes); a cache coherency layer (e.g., a layer associated with a CXL.cache protocol, which may be used for purposes such as caching host memory using a modified, exclusive, shared, invalid (MESI) coherence protocol, or similar purposes); or a memory protocol layer (e.g., a layer associated with a CXL.memory (sometimes referred to as CXL.mem) protocol, which may enable a CXL memory device to expose host-managed device memory (HDM) to permit a host device to manage and access memory similar to a native DDR connected to the host); among other examples.

The CXL compliant memory system 204 may further include and/or be associated with one or more high-bandwidth memory modules (HBMMs) or similar memory arrays (e.g., CXL device attached memory 218). For example, the CXL compliant memory system 204 may include multiple layers of DRAM (e.g., stacked and/or interconnected through advanced through-silicon via (TSV) technology) in order to maximize storage density and/or enhance data transfer speeds between memory layers. Additionally, or alternatively, the CXL compliant memory system 204 (e.g., a CXL ASIC of the CXL compliant memory system 204) may include a power management unit, which may be configured to regulate power consumption associated with the CXL compliant memory system 204 and/or which may be configured to improve energy efficiency for the CXL compliant memory system 204. Additionally, or alternatively, the CXL compliant memory system 204 (e.g., a CXL ASIC of the CXL compliant memory system 204) may include additional components, such as one or more error correction code (ECC) engines, such as for a purpose of detecting and/or correcting data errors to ensure data integrity and/or improve the overall reliability of the CXL compliant memory system 204. The CXL compliant memory system 204 may be implemented using a combination of hardware and firmware blocks and/or components. In such examples, the firmware may execute on one or more embedded CPUs within the CXL compliant memory system 204.

Additionally, or alternatively, the CXL compliant memory system 204 and/or a CXL memory system controller (e.g., a CXL ASIC) of the CXL compliant memory system 204 may include CXL host interface hardware 210, an I/O path hardware logic and DMA controller 212, a main management subsystem 214, and/or a host interface (HIF) management subsystem 216, among other examples. In some examples, the CXL host interface hardware 210 may be hardware components that enable physical connectivity between the CXL compliant memory system 204 and one or more external devices, such as to the CXL host 202 via the CXL bus 208. In some examples, the CXL host interface hardware 210 may include the necessary physical interfaces and protocol logic required to establish and/or maintain communication over the CXL link (e.g., via the CXL bus 208). In some cases, the CXL host interface hardware 210 may ensure that the CXL host 202 can access and/or control the CXL compliant memory system 204 efficiently.

The I/O path hardware logic and DMA controller 212 may handle data transfers between the CXL compliant memory system 204 and external devices, such as other memory modules and/or peripheral components. In some examples, a DMA controller portion of the I/O path hardware logic and DMA controller 212 may permit efficient data transfer without involving a CXL compliant memory system 204 CPU, directly. Put another way, the DMA controller portion of the I/O path hardware logic and DMA controller 212 may manage data movement between the CXL compliant memory system 204 and other system components, which may enhance overall system performance by offloading data transfer tasks from the CPU.

The main management subsystem 214 may serve as a central control and management unit within the CXL compliant memory system 204. In some examples, the main management subsystem 214 may encompass various functionalities and tasks, such as memory access control, error detection and/or correction, power management, and/or similar system management functionalities and/or tasks. Additionally, or alternatively, the main management subsystem 214 may ensure proper functioning and/or reliability of the CXL compliant memory system 204 and/or may optimize the performance of the CXL compliant memory system 204 under various operating conditions.

The HIF management subsystem 216 may be responsible for managing and/or controlling the CXL host interface hardware 210, among other tasks. In some examples, the HIF management subsystem 216 may handle tasks related to link initialization configuration negotiation with the CXL host 202, error handling, and/or other protocol-specific functionalities. Additionally, or alternatively, the HIF management subsystem 216 may ensure smooth communication between the CXL compliant memory system 204 and/or the CXL host 202, such as by maintaining compatibility and/or reliability of the CXL link, among other examples.

In some examples, the CXL compliant memory system 204 may be categorized as a CXL type 1 device, a CXL type 2 device, or a CXL type 3 device. A CXL type 1 device may be a device that implements a coherent cache using the CXL.cache protocol. A CXL type 2 device may be a device that implements both a coherent cache using the CXL.cache protocol and a host-managed device memory using the CXL.mem protocol. For example, a CXL type 2 device may be a hardware accelerator device. A CXL type 3 device may be a device that implements a host-managed device memory using the CXL.mem protocol. For example, a CXL type 3 device may be a memory expander device.

The number and arrangement of components shown in FIG. 2 are provided as an example. In practice, there may be additional components, fewer components, different components, or differently arranged components than those shown in FIG. 2. Furthermore, two or more components shown in FIG. 2 may be implemented within a single component, or a single component shown in FIG. 2 may be implemented as multiple, distributed components. Additionally, or alternatively, a set of components (e.g., one or more components) shown in FIG. 2 may perform one or more operations described as being performed by another set of components shown in FIG. 2.

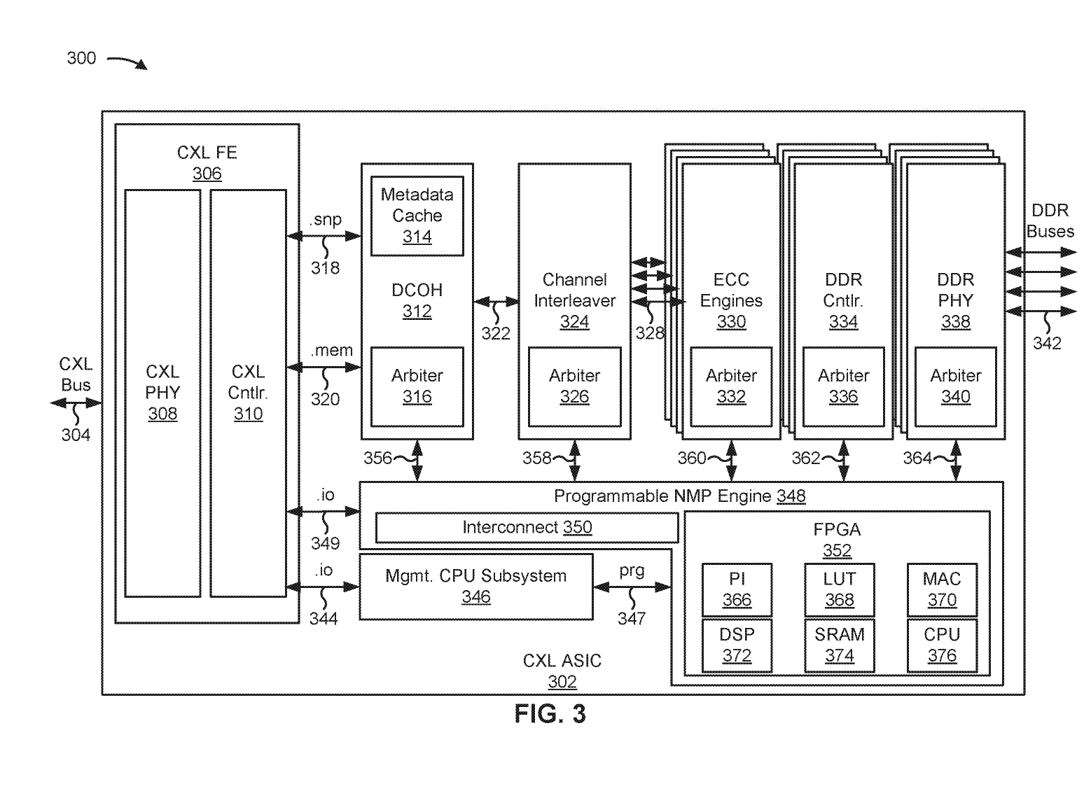

FIG. 3 is a diagram of an example 300 associated with a programmable NMP engine for a managed memory system. The operations described in connection with FIG. 3 may be performed by the memory system 110 and/or one or more components of the memory system 110, such as the memory system controller 115, one or more memory devices 120, and/or one or more local controllers 125, and/or the CXL compliant memory system 204 and/or one or more components of the CXL compliant memory system 204, such as the CXL host interface hardware 210, the I/0 path hardware logic and DMA controller 212, the main management subsystem 214, the HIF management subsystem 216, and/or the CXL device attached memory 218. Additionally, or alternatively, the components shown in connection with example 300 may correspond to one or more components described above in connection with FIGS. 1 and 2. In that regard, although for ease of description the example is described in the context of a CXL compliant memory system and/or a CXL ASIC 302, in some other implementations the operations described in connection with FIG. 3 may be implemented by another type of managed memory device, such as an SSD, managed NAND, a high bandwidth memory (HBM) system (e.g., an HBM5 system or similar HBM system), or similar managed memory device. In some implementations, the CXL ASIC 302 may be associated with a CXL Type 3 device.

As shown in FIG. 3, the example 300 includes the CXL ASIC 302, which may correspond to one or more components described above in connection with the CXL compliant memory system 204. The CXL ASIC 302 may be communicatively coupled to a host system (e.g., CXL host 202), such as via a CXL bus 304 (e.g., CXL bus 208). Moreover, the CXL ASIC 302 may include a CXL frontend (FE) component 306, which may be a hardware interface that facilitates communication and data transfer between the CXL bus 304 and the various components of the CXL ASIC 302. In that regard, the CXL frontend component 306 may, in some implementations, be associated with a PCIe frontend. Additionally, or alternatively, the CXL frontend component 306 may include a CXL physical layer (PHY) component 308 and/or a CXL controller 310. The CXL PHY component 308 may enable PHY communications to a host device, such as by using the PCIe protocol. Moreover, the CXL controller 310 may be in communication with one or more components of the CXL ASIC 302 via one or more interfaces associated with snooping commands (e.g., commands associated with the CXL.snp protocol, shown in FIG. 3 simply as “.snp”), memory commands (e.g., commands associated with the CXL.mem protocol, shown in FIG. 3 simply as “.mem”), and/or control commands (e.g., commands associated with the CXL.io protocol, shown in FIG. 3 simply as “.io”).

For example, in some implementations, the CXL ASIC 302 may include a device coherency (DCOH) component 312, such as in implementations in which a corresponding CXL device is to enable hardware coherency with respect to multiple host devices connecting to the CXL device. In some implementations, the DCOH component 312 may be a coherent NoC component, and/or the DCOH component 312 may ensure that changes made by one host device are immediately visible to all other host devices accessing the same data, such as for a purpose of ensuring consistency of shared data across multiple host devices.

In such implementations, the DCOH component 312 may include a metadata cache component 314 and/or an arbiter component 316. The metadata cache component 314 may be a specialized cache that stores metadata information required to maintain and manage data coherence across the multiple processing elements (e.g., multiple host devices). The arbiter component 316 may manage and/or coordinate access to shared resources associated with the DCOH component 312 among multiple requesting units in a system, such as the CXL frontend component 306 (e.g., the CXL controller 310 of the CXL frontend component 306), a programmable NMP engine 348 (which is described in more detail below), and/or a channel interleaver component 324 (also described in more detail below).

Moreover, the DCOH component 312 may be operatively connected to, and/or in communication with, the CXL controller 310 via one or more interfaces and/or interconnects, such as via a snooping interface 318 (e.g., an interface associated with CXL.snp commands) and/or a memory command interface 320 (e.g., an interface associated with CXL.mem commands). The snooping interface 318 may be used to handle snooping transactions (e.g., requests sent to check, and possibly update, the state of caches to maintain coherence), which are part of a cache coherence protocol. The memory command interface 320 may facilitate communication between the memory devices (e.g., DDR and/or DRAM devices) and the rest of the system (e.g., the CXL controller 310) and/or may be associated with data, address, and/or control signal transfers necessary for memory operations.

As indicated by reference number 322, the DCOH component 312 may further be operatively connected to, and/or in communication with, the channel interleaver component 324. The channel interleaver component 324 may be a component that distributes memory access requests across a discrete number of memory channels (e.g., DDR channels) to optimize bandwidth usage and performance. In some implementations, the channel interleaver component 324 may be responsible for mapping physical address spaces and managing data flow through channels. Moreover, the channel interleaver component 324 may aid in load balancing, reducing latency, and/or minimizing access conflicts, such as for a purpose of ensuring efficient use of all available memory channels and/or improving overall system performance. Moreover, in some implementations, the channel interleaver component 324 may include an arbiter component 326, which may be substantially similar to the arbiter component 316 described above in connection with the DCOH component 312. In that regard, the arbiter component 326 may manage and/or coordinate access to shared resources associated with the channel interleaver component 324 among multiple requesting units in a system, such as the DCOH component 312, the programmable NMP engine 348, and/or one or more memory channels.

As indicated by reference number 328, the channel interleaver component 324 may further be operatively connected to, and/or in communication with, a discrete number of DDR channels or similar memory channels, with each DDR channel including a corresponding ECC engine 330, a corresponding DDR controller 334, and/or a corresponding DDR PHY component 338 that is operatively connected to a memory device (e.g., a DRAM device, not shown) via a respective DDR bus 342. Each ECC engine 330, DDR controller 334, and/or DDR PHY component 338 may be associated with a corresponding arbiter component 332, arbiter component 336, or arbiter component 340, respectively. The arbiter components 332, 336, 340 may be substantially similar to the other arbiter components 316, 326 described above and/or may coordinate access to shared resources among multiple requesting units in a system, such as the channel interleaver component 324, the programmable NMP engine 348, and/or the memory components (e.g., DRAM components).

The ECC engine 330 for each DDR channel may be responsible for detecting and correcting errors in data as it is read from or written to memory via the corresponding channel. In some implementations, the ECC engine 330 may ensure data integrity by using algorithms to identify and fix single-bit or multi-bit errors, thus preventing data corruption and enhancing the reliability of the memory system. The DDR controller 334 for each DDR channel may manage data communication between the memory components and the system’s CPU (e.g., the CXL controller 310) or other processors. In some implementations, the DDR controller 334 orchestrates memory read and write operations, handles address mapping, ensures proper timing and synchronization, and/or manages power states to optimize performance and energy efficiency. Additionally, or alternatively, the DDR controller 334 may act as an intermediary that ensures efficient and reliable data transfer between the memory and the rest of the system. The DDR PHY component 338 for each DDR channel may handle the physical interface between a corresponding DDR controller 334 and the memory modules, such as via a corresponding DDR bus 342. In some implementations, the DDR PHY component 338 may be responsible for managing the electrical signaling, timing, and data transfer at the hardware level, including tasks such as signal integrity, clock alignment, and data serialization/deserialization. Additionally, or alternatively, the DDR PHY component 338 may ensure that data is accurately transmitted and received across the physical memory interface, enabling reliable high-speed communication between the memory and the rest of the system.

As indicated by reference number 344, the CXL frontend component 306, and more particularly the CXL controller 310, may be operatively connected to, or otherwise in communication with, a management CPU subsystem 346, such as via the CXL.io protocol. In some implementations, the management CPU subsystem 346 may be associated with a sideband channel. Additionally, or alternatively, the management CPU subsystem 346 may be a component of the CXL ASIC 302 that is used for purposes such as device discovery, configuration, initialization, I/O virtualization, DMA using non-coherent load-store semantics, designative vendor-specific extended capability (DVSEC) functionality (e.g., an extended capability structure that enables hardware vendors to implement custom features and functionalities that are specific to their devices), mailbox functionality (e.g., a communication mechanism used for passing messages or commands between different components or subsystems within the device, which may be associated with and/or implemented as dedicated registers or memory regions that both the host and the memory device can access, ensuring a reliable and efficient means of communication), host-device communications, and/or similar purposes.

As indicated by reference number 347, the management CPU subsystem 346 may be operatively connected to, or otherwise in communication with, the programmable NMP engine 348. In this way, the management CPU subsystem 346 may be configured to exchange programming information (shown in FIG. 3 as “prg”) with the programmable NMP engine 348. In such implementations, the management CPU subsystem 346 may act as a programmable NMP engine 348 interface that is capable of transmitting programming information received from the host device and intended for the programmable NMP engine 348 (sometimes referred to herein as host-NMP programming information) to the programmable NMP engine 348.

Additionally, or alternatively, as indicated by reference number 349, the programmable NMP engine 348 may be operatively connected to, or otherwise in communication with, the CXL frontend component 306 (more particularly, the CXL controller 310), such as via a CXL.io interface or similar interface. In such implementations, the programmable NMP engine 348 may be capable of receiving programming information directly from the CXL frontend component 306, instead of or in addition to receiving programming information from the management CPU subsystem 346.

In some implementations, the programmable NMP engine 348 may include an interconnect component 350. The interconnect component 350 may include communication pathways and/or associated infrastructure to facilitate information transfer between the programmable NMP engine 348 and various other components of the CXL ASIC 302, such as the CXL frontend component 306 (more particularly the CXL controller 310 of the CXL frontend component 306), the DCOH component 312, the channel interleaver component 324, the ECC engines 330, the DDR controllers 334, and/or the DDR PHY components 338. In this way, the programmable NMP engine 348 may be operatively connected to, or otherwise in communication with, the DCOH component 312, the channel interleaver component 324, the ECC engines 330, the DDR controllers 334, and/or the DDR PHY components 338 via auxiliary data channels (as shown in FIG. 3 by reference numbers 356, 358, 360, 362, and 364, respectively), such as for a purpose of performing NMP tasks associated with the various components of the CXL ASIC 302.

In some implementations, the programmable NMP engine 348 may include an FPGA 352 (e.g., an eFPGA) that is configured to perform NMP tasks (e.g., that is programmable to perform specific logic functions associated with NMP tasks). In some implementations, the FPGA 352 may be capable of being reprogrammed (e.g., via the CXL.io channel) to accommodate updates or changes in the requirements of the system. For example, as new functionalities or optimizations are developed, the FPGA 352 may be reconfigured, extending the usefulness and adaptability of the programmable NMP engine 348, which is described in more detail below.

In some implementations, the FPGA 352 may include one or more subsystems and/or subcomponents configured to enable certain NMP tasks. For example, the FPGA 352 may include and/or be otherwise associated with a programmable interconnect (PI) component 366, a look-up-table (LUT) component 368, a multiply-accumulate (MAC) component 370, a digital signal processing (DSP) component 372, an SRAM component 374, a CPU 376, and/or a similar component.

The PI component 366 may enable various logic blocks and/or components of the FPGA 352 (e.g., the LUT component 368, the MAC component 370, the DSP component 372, the SRAM component 374, the CPU 376, and/or a similar component) to be connected in a flexible and configurable manner. In that regard, the PI component 366 may enable the configurable routing of signals between the different logic blocks and/or components of the FPGA 352 based on the needs of the specific application and/or design being implemented in the FPGA 352. In some implementations, the PI component 366 may include and/or may be associated with a switch matrix, routing channels, switch boxes, and/or programmable connections.

The LUT component 368 may be configured to utilize one or more LUTs to implement logic functions associated with the FPGA 352. The MAC component 370 may be configured to perform certain signal processing tasks related to digital filtering, fast Fourier transforms (FFTs), and/or other numerical computations, such as by multiplying to numbers together and/or adding the result to an accumulator. The DSP component 372 may be a component that is optimized for performing high-speed arithmetic operations, such as operations associated with filtering, FFTs, and/or complex mathematical computations.

The SRAM component 374 may be a memory component that stores data to be accessed quickly by the programmable NMP engine 348, such as for a purpose of implementing fast, on-chip memory resources. The CPU 376 may be a supplementary processing unit capable of assisting host to programmable NMP engine 348 interactions. For example, in some implementations (e.g., implementations in which the programmable NMP engine 348 receives programming information directly from the CXL controller 310 via the interface indicated by reference number 349 and/or via the CXL.io protocol, among other examples), the FPGA 352 may implement the CPU 376 for assisting host-to-NMP interactions (e.g., for receiving and/or applying configuration information, commands, logs, quality of service (QoS) information, statistics, and/or similar information).

In some implementations, the programmable NMP engine 348 may be capable of receiving, from a host system (e.g., CXL host 202), programming information indicating one or more NMP tasks that are to be performed by the programmable NMP engine, and/or the programmable NMP engine 348 may be capable of executing the one or more NMP tasks based on the programming information. In some implementations, the programmable NMP engine 348 may receive the programming information via the management CPU subsystem 346, as described above. In some other implementations, such as implementations in which the FPGA 352 includes the CPU 376 and/or in which the programmable NMP engine 348 includes the interface indicated by reference number 349, the programmable NMP engine 348 may be capable of receiving programming information directly from the CXL controller 310 and/or via the CPU 376.

The NMP tasks may be any tasks associated with computations that are performed directly within the memory (rather than at a host system), such as tasks that involve large volumes of data and thus would be associated with high latency and/or reduced bandwidth to perform the necessary data transfer to the host system for computation. In some implementations, the NMP tasks may include memory copying tasks, vector-matrix multiplication tasks, user-function tasks, BIST operations, extended error recovery operations, DMA tasks, and/or similar NMP tasks. Put another way, the FPGA-based programmable NMP engine 348 may be capable of performing background execution of NMP operations, such as memory copying operations, vector-matrix multiplier operations, user functions, manufacturing features such as BIST, in-system features for memory testing, extended error recovery operations, and/or PCIe DMA operations, among other examples, in order to reduce latency, increase bandwidth, and otherwise result in more efficient memory system operations. Additionally, or alternatively, the programmable NMP engine 348 may be capable of communicating with the DCOH component 312, such as for a purpose of executing operations related to hardware coherency.

In some implementations, the programmable NMP engine 348 may be programmed at runtime, such as by implementing dedicated host software libraries. In such implementations, users may be capable of expanding the libraries using one or more API interfaces. Additionally, or alternatively, users may be capable of implementing the dedicated hardware (e.g., the programmable NMP engine 348) using an embedded FPGA toolchain, such as a suite of software tools designed to program and configure the FPGA 352 that are integrated within a memory system or other embedded system incorporating the programmable NMP engine 348.

In this way, implementing the programmable NMP engine 348 in a CXL compliant memory system or similar managed memory system may enhance the efficiency of processing engines by integrating specialized algorithms and leveraging dedicated hardware components to perform NMP tasks, ensuring optimized performance and improved processing capabilities. Additionally, or alternatively, implementing the programmable NMP engine 348 in a managed memory system may enable defining NMP functionality at runtime, defining a high-speed testing function (e.g., a BIST) at a predefined level of a data path, may remove the limitations of fixed- function NMP designs, may optimize power, area, and memory usage compared to multi-CPU NMP designs, and/or may otherwise improve memory system performance thus resulting in reduced power, computing, memory, and storage resource consumption.

As indicated above, FIG. 3 is provided as an example. Other examples may differ from what is described with regard to FIG. 3.

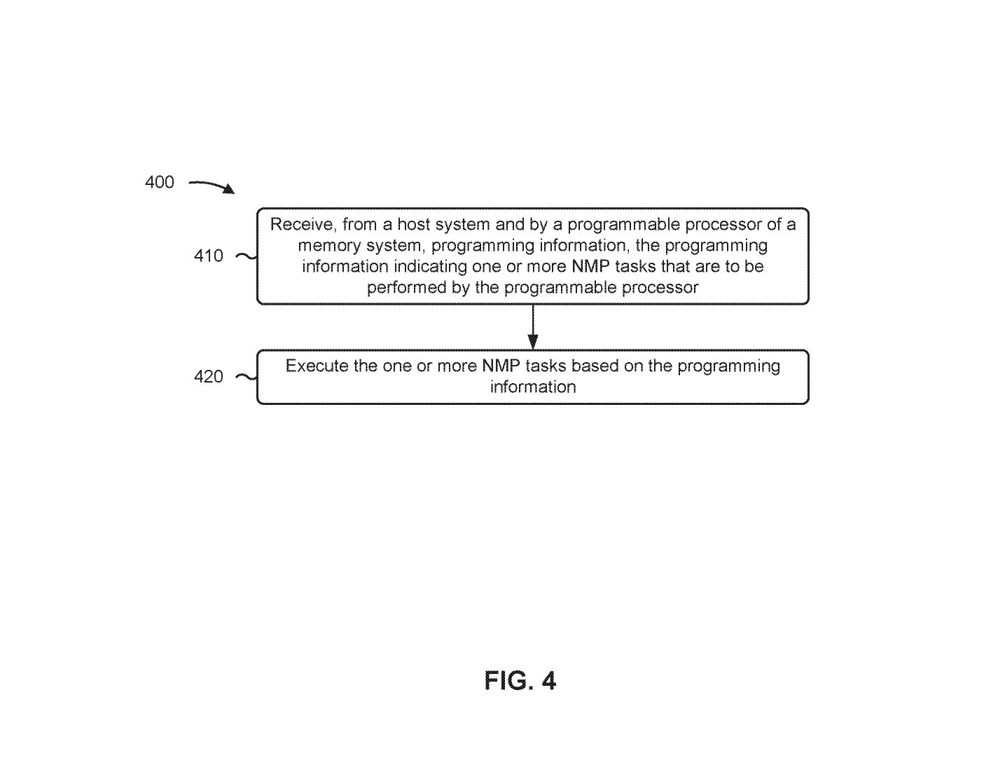

FIG. 4 is a flowchart of an example method 400 associated with a programmable NMP engine for a managed memory system. In some implementations, a programmable processor, such as a programmable NMP component (e.g., the programmable NMP engine 348), may perform or may be configured to perform the method 400. In some implementations, another device or a group of devices separate from or including the programmable processor (e.g., memory system 110, memory system controller 115, memory device 120, local controller 125, CXL compliant memory system 204, CXL host interface hardware 210, I/O path hardware logic and DMA controller 212, main management subsystem 214, HIF management subsystem 216, CXL device attached memory 218, CXL frontend component 306, CXL PHY component 308, CXL controller 310, DCOH component 312, channel interleaver component 324, ECC engine 330, DDR controller 334, DDR PHY component 338, and/or management CPU subsystem 346) may perform or may be configured to perform the method 400. Additionally, or alternatively, one or more components of the programmable processor (e.g., interconnect component 350, FPGA 352, PI component 366, LUT component 368, MAC component 370, DSP component 372, SRAM component 374, and/or CPU 376) may perform or may be configured to perform the method 400. Thus, means for performing the method 400 may include the programmable processor and/or one or more components of the programmable processor. Additionally, or alternatively, a non-transitory computer-readable medium may store one or more instructions that, when executed by the programmable processor, cause the programmable processor to perform the method 400.

As shown in FIG. 4, the method 400 may include receiving, from a host system and by a programmable processor of a memory system, programming information, the programming information indicating one or more NMP tasks that are to be performed by the programmable processor (block 410). For example, as described above in connection with FIG. 3, the programmable NMP engine 348 may receive, from a host system (e.g., via the CXL bus 304, the CXL frontend component 306, the CXL PHY component 308, the CXL controller 310, and/or the management CPU subsystem 346) programming information indicating one or more NMP tasks to be performed by the programmable NMP engine 348.

As further shown in FIG. 4, the method 400 may include executing the one or more NMP tasks based on the programming information (block 420). For example, as described above in connection with FIG. 3, the programmable NMP engine 348 may execute one or more NMP tasks, such by using one or more of the interconnect component 350, the FPGA 352, the PI component 366, the LUT component 368, the MAC component 370, the DSP component 372, the SRAM component 374, and/or the CPU 376, and/or by communicating with one or more components of the CXL ASIC 302 via one or more auxiliary data channels, such as by communicating with the DCOH component 312 via the auxiliary data channel indicated by reference number 356, by communicating with the channel interleaver component 324 via the auxiliary data channel indicated by reference number 358, by communicating with one or more ECC engines 330 via the auxiliary data channel indicated by reference number 360, by communicating with one or more DDR controllers 334 via the auxiliary data channel indicated by reference number 362, and/or by communicating with one or more DDR PHY components 338 via the auxiliary data channel indicated by reference number 364.

The method 400 may include additional aspects, such as any single aspect or any combination of aspects described below and/or described in connection with one or more other methods or operations described elsewhere herein.

In a first aspect, the method 400 includes initializing, by the programmable processor, a set of user-defined algorithms for execution as part of the one or more NMP tasks. For example, in a similar manner as described above in connection with FIG. 3, the programmable NMP engine 348 may receive programming information directly from the CXL controller 310 and/or via the management CPU subsystem 346, and the programmable NMP engine 348 (e.g., the FPGA 352 of the programmable NMP engine 348) may initialize a set of user-defined algorithms indicated by the programming information.

In a second aspect, alone or in combination with the first aspect, the method 400 includes interfacing, by the programmable processor, with a host software library for real-time programming of the one or more NMP tasks. For example, in a similar manner as described above in connection with FIG. 3, a host system may be associated with a software library that indicates candidate tasks to be performed by the programmable NMP engine 348. In such implementations, the programmable NMP engine 348 may interface with the host software libraries (e.g., via the CXL bus 304, the CXL frontend component 306, the CXL PHY component 308, the CXL controller 310, and/or the management CPU subsystem 346), such as to receive real-time programming information from the host system.

In a third aspect, alone or in combination with one or more of the first and second aspects, the programming information is associated with user instructions provided via an application programming interface associated with the host system. For example, in a similar manner as described above in connection with FIG. 3, the host system may include an API or similar tool that enables programming of the programmable NMP engine 348 (e.g., the FPGA 352 of the programmable NMP engine 348).

In a fourth aspect, alone or in combination with one or more of the first through third aspects, the programmable processor is associated with an FPGA, and receiving the programming information includes receiving the programming information via an FPGA toolchain. For example, in a similar manner as described above in connection with FIG. 3, the programmable NMP engine 348 may be associated with an eFPGA (e.g., the FPGA 352) and/or may be programmable at a host system via a toolchain associated with the FPGA.

In a fifth aspect, alone or in combination with one or more of the first through fourth aspects, the method 400 includes performing, by the programmable processor, background execution of the one or more NMP tasks while primary memory operations are conducted by one or more memory controllers associated with the memory system. For example, in a similar manner as described above in connection with FIG. 3, the programmable NMP engine 348 may perform the NMP tasks in a background while primary memory operations are conducted by the CXL controller 310 and/or the one or more DDR controllers 334.

In a sixth aspect, alone or in combination with one or more of the first through fifth aspects, executing the one or more NMP tasks includes executing a built-in self-test of the memory system. For example, in a similar manner as described above in connection with FIG. 3, the programmable NMP engine 348 may be capable of handling one or more NMP tasks, such as BIST operations, among other examples.

In a seventh aspect, alone or in combination with one or more of the first through sixth aspects, the one or more NMP tasks include at least one of memory copying tasks, vector-matrix multiplication tasks, or user-function tasks. For example, in a similar manner as described above in connection with FIG. 3, using one or more of the FPGA 352, the PI component 366, the LUT component 368, the MAC component 370, the DSP component 372, the SRAM component 374, and/or the CPU 376, the programmable NMP engine 348 may perform certain NMP tasks, such as memory copying tasks, vector-matrix multiplication tasks, and/or user-function tasks, among other examples.

In an eighth aspect, alone or in combination with one or more of the first through seventh aspects, the one or more NMP tasks include in-system memory testing tasks. For example, in a similar manner as described above in connection with FIG. 3, using one or more of the FPGA 352, the PI component 366, the LUT component 368, the MAC component 370, the DSP component 372, the SRAM component 374, and/or the CPU 376, the programmable NMP engine 348 may perform certain NMP tasks, such as in-system memory testing tasks, among other examples.

In a ninth aspect, alone or in combination with one or more of the first through eighth aspects, the one or more NMP tasks are associated with an extended error recovery process. For example, in a similar manner as described above in connection with FIG. 3, using one or more of the FPGA 352, the PI component 366, the LUT component 368, the MAC component 370, the DSP component 372, the SRAM component 374, and/or the CPU 376, the programmable NMP engine 348 may perform certain NMP tasks, such as an extended error recovery process for the memory system, among other examples.

In a tenth aspect, alone or in combination with one or more of the first through ninth aspects, the one or more NMP tasks are associated with a peripheral component interconnect express direct memory access operation. For example, in a similar manner as described above in connection with FIG. 3, using one or more of the PI component 366, the LUT component 368, the MAC component 370, the DSP component 372, the SRAM component 374, and/or the CPU 376, the programmable NMP engine 348 may perform certain NMP tasks, such as tasks associated with a PCIe DMA operation, among other examples.

In an eleventh aspect, alone or in combination with one or more of the first through tenth aspects, the method 400 includes managing, by the programmable processor, data coherency of the memory system by communicating with a coherent network on chip component associated with the memory system. For example, in a similar manner as described above in connection with FIG. 3, using one or more of the PI component 366, the LUT component 368, the MAC component 370, the DSP component 372, the SRAM component 374, and/or the CPU 376, the programmable NMP engine 348 may interface with the DCOH component 312 via the auxiliary data channel indicated by reference number 356, such as to manage data coherency of the memory system, among other examples.

Although FIG. 4 shows example blocks of a method 400, in some implementations, the method 400 may include additional blocks, fewer blocks, different blocks, or differently arranged blocks than those depicted in FIG. 4. Additionally, or alternatively, two or more of the blocks of the method 400 may be performed in parallel. The method 400 is an example of one method that may be performed by one or more devices described herein. These one or more devices may perform or may be configured to perform one or more other methods based on operations described herein.

In some implementations, a memory system includes one or more memory components; one or more memory controllers operatively connected to the one or more memory components; and a programmable processor operatively connected to at least one of the one or more memory controllers or the one or more memory components, the programmable processor configured to: receive, from a host system, programming information indicating one or more near memory processing (NMP) tasks that are to be performed by the programmable processor; and execute the one or more NMP tasks based on the programming information.

In some implementations, a method includes receiving, from a host system and by a programmable processor of a memory system, programming information, the programming information indicating one or more NMP tasks that are to be performed by the programmable processor; and executing, by the programmable processor, the one or more NMP tasks based on the programming information.

In some implementations, a memory expander device includes one or more compute express link (CXL) compliant memory components; one or more memory controllers operatively connected to the one or more CXL compliant memory components; and a programmable near memory processing (NMP) engine embedded within the memory expander device and operatively connected to at least one of the one or more memory controllers or the one or more CXL compliant memory components, the programmable NMP engine configured to: receive, via a programmable interface associated with a host system, programming instructions during runtime of the memory expander device; and execute data processing tasks associated with the programming instructions.

The foregoing disclosure provides illustration and description but is not intended to be exhaustive or to limit the implementations to the precise forms disclosed. Modifications and variations may be made in light of the above disclosure or may be acquired from practice of the implementations described herein.

As used herein, the terms “substantially” means “within reasonable tolerances of manufacturing and measurement.”

Even though particular combinations of features are recited in the claims and/or disclosed in the specification, these combinations are not intended to limit the disclosure of implementations described herein. Many of these features may be combined in ways not specifically recited in the claims and/or disclosed in the specification. For example, the disclosure includes each dependent claim in a claim set in combination with every other individual claim in that claim set and every combination of multiple claims in that claim set. As used herein, a phrase referring to “at least one of” a list of items refers to any combination of those items, including single members. As an example, “at least one of: a, b, or c” is intended to cover a, b, c, a + b, a + c, b + c, and a + b + c, as well as any combination with multiples of the same element (e.g., a + a, a + a + a, a + a + b, a + a + c, a + b + b, a + c + c, b + b, b + b + b, b + b + c, c + c, and c + c + c, or any other ordering of a, b, and c).

When “a component” or “one or more components” (or another element, such as “a controller” or “one or more controllers”) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Where only one item is intended, the phrase “only one,” “single,” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. As used herein, the term “multiple” can be replaced with “a plurality of” and vice versa. Also, as used herein, the term “or” is intended to be inclusive when used in a series and may be used interchangeably with “and/or,” unless explicitly stated otherwise (e.g., if used in combination with “either” or “only one of”).

What is claimed is:

1. A memory system, comprising:
one or more memory components;
one or more memory controllers operatively connected to the one or more memory components; and
a programmable processor operatively connected to at least one of the one or more memory controllers or the one or more memory components, the programmable processor configured to:
receive, from a host system, programming information indicating one or more near memory processing (NMP) tasks that are to be performed by the programmable processor; and
execute the one or more NMP tasks based on the programming information.

2. The memory system of claim 1, wherein the programmable processor is associated with a field programmable gate array.

3. The memory system of claim 1, wherein the one or more NMP tasks include at least one of:
memory copying tasks,
vector-matrix multiplication tasks, or
user-function tasks.

4. The memory system of claim 1, wherein the programmable processor, to receive the programming information, is configured to receive the programming information via a one or more dedicated software libraries associated with the programmable processor.

5. The memory system of claim 1, wherein the memory system is a compute express link (CXL) compliant memory system.

6. The memory system of claim 5, wherein the programmable processor, to receive the programming information, is configured to receive the programming information via a CXL.io channel.

7. The memory system of claim 1, wherein the memory system is one of a solid state drive or a high bandwidth memory system.

8. The memory system of claim 1, wherein the programmable processor, to receive the programming information, is configured to receive the configuration at runtime.

9. The memory system of claim 1, wherein the one or more NMP tasks includes a built-in self-test operation.

10. The memory system of claim 1, wherein the programming information is associated with user instructions provided via an application programming interface associated with the host system.

11. The memory system of claim 1, wherein the one of the one or more NMP tasks includes extended error recovery operations.

12. The memory system of claim 1, wherein the memory system further comprises a coherent network on chip (NoC) component, and
wherein the programmable processor is further configured to communicate with the coherent NoC component to execute operations related to hardware coherency.

13. The memory system of claim 1, wherein the programmable processor includes a central processing unit (CPU), and
wherein the programmable processor, to receive the programming information, is configured to receive the programming information via the CPU.

14. A method, comprising:
receiving, from a host system and by a programmable processor of a memory system, programming information, the programming information indicating one or more near memory processing (NMP) tasks that are to be performed by the programmable processor; and
executing, by the programmable processor, the one or more NMP tasks based on the programming information.

15. The method of claim 14, further comprising initializing, by the programmable processor, a set of user-defined algorithms for execution as part of the one or more NMP tasks.

16. The method of claim 14, further comprising interfacing, by the programmable processor, with a host software library for real-time programming of the one or more NMP tasks.

17. The method of claim 14, wherein the programming information is associated with user instructions provided via an application programming interface associated with the host system.

18. The method of claim 14, wherein the programmable processor is associated with a field programmable gate array (FPGA), and
wherein receiving the programming information includes receiving the programming information via an FPGA toolchain.

19. The method of claim 14, further comprising performing, by the programmable processor, background execution of the one or more NMP tasks while primary memory operations are conducted by one or more memory controllers associated with the memory system.

20. The method of claim 14, wherein executing the one or more NMP tasks includes executing a built-in self-test of the memory system.

21. The method of claim 14, wherein the one or more NMP tasks include at least one of:
memory copying tasks,
vector-matrix multiplication tasks, or
user-function tasks.

22. The method of claim 14, wherein the one or more NMP tasks include in-system memory testing tasks.

23. The method of claim 14, wherein the one or more NMP tasks are associated with an extended error recovery process.

24. The method of claim 14, wherein the one or more NMP tasks are associated with a peripheral component interconnect express direct memory access operation.

25. The method of claim 14, further comprising managing, by the programmable processor, data coherency of the memory system by communicating with a coherent network on chip component associated with the memory system.

26. A memory expander device, comprising:
one or more compute express link (CXL) compliant memory components;
one or more memory controllers operatively connected to the one or more CXL compliant memory components; and
a programmable near memory processing (NMP) engine embedded within the memory expander device and operatively connected to at least one of the one or more memory controllers or the one or more CXL compliant memory components, the programmable NMP engine configured to:
receive, via a programmable interface associated with a host system, programming instructions during runtime of the memory expander device; and
execute data processing tasks associated with the programming instructions.

27. The memory expander device of claim 26, wherein the programmable NMP engine includes an embedded field programmable gate array.

28. The memory expander device of claim 26, wherein the data processing tasks include at least one of:
memory copying tasks,
data transformation tasks,
vector-matrix multiplication task, or
user-defined tasks.

29. The memory expander device of claim 26, wherein the programmable NMP engine is further configured to perform a built-in self-test operation for the memory expander device.

30. The memory expander device of claim 26, wherein the programmable NMP engine is further configured to communicate with the host system via a sideband channel.

31. The memory expander device of claim 26, wherein the programmable NMP engine is configured to execute in-system memory testing functions in parallel with normal memory expander device operation.

32. The memory expander device of claim 26, wherein the programmable NMP engine is further configured to execute extended error recovery operations.

33. The memory expander device of claim 26, wherein the programmable NMP engine includes a supplementary processing unit configured to communicate with the host system.

34. The memory expander device of claim 26, wherein the programmable NMP engine is configurable to support hardware coherency via communication with a coherent network on chip component interfaced with the one or more CXL compliant memory components.
